(19) United States
(12) Patent Application Publication
(10) Pub. No.: US 2009/0233688 A1
(43) Pub. Date: Sep. 17, 2009

(54) GAMING SYSTEM AND A METHOD OF GAMING

(75) Inventor: Samuel James Walker, Artarmon (AU)

Correspondence Address: HANLEY, FLIGHT & ZIMMERMAN, LLC, 150 S. WACKER DRIVE, SUITE 2100, CHICAGO, IL, 60606, US

(73) Assignee: Aristocrat Technologies australia Pty Limited, North Ryde (AU)

(21) Appl. No.: 12/401,298

(22) Filed: Mar. 10, 2009

(30) Foreign Application Priority Data
Mar. 10, 2008 (AU) 2008901124

(51) Int. Cl. A63F 9/24; A63F 13/00

(52) U.S. Cl. 463/20; 463/30

(57) ABSTRACT

A gaming system is disclosed which includes a symbol selector arranged to select a plurality of symbols for display at a plurality of display positions, a win criterion selector arranged to facilitate selection by a player of at least one win criterion from a plurality of win criteria, and an outcome evaluator arranged to determine whether the selected symbols correspond to a winning outcome. The system also includes a prize allocator arranged to allocate a prize to a player when a winning outcome exists and to allocate a different prize to the player when the selected symbols satisfy the selected win criterion. A corresponding method is also disclosed.

### CROSS-REFERENCE TO RELATED APPLICATIONS

The present application claims the benefit of priority to Australian Provisional Patent Application No. 2008901124, filed on Mar. 10, 2008, entitled “A GAMING SYSTEM AND A METHOD OF GAMING”, which is herein incorporated by reference in its entirety.

### FIELD OF THE INVENTION

The present invention relates to a gaming system and to a method of gaming.

### BACKGROUND OF THE INVENTION

It is known to provide a gaming system which comprises a game controller arranged to randomly display several symbols from a predetermined set of symbols and to determine a game outcome such as a game win based on the displayed symbols. In some arrangements, a win outcome is defined on the basis of occurrence of symbols along defined win lines which may be preselected or selected by a player prior to display of symbols by the gaming system.

Such gaming systems may commonly be implemented as a stepper machine provided with reels with each reel carrying several symbols of the set, or a video machine wherein selected symbols are displayed on virtual reels on a graphical display device.

However, while such gaming systems provide users with enjoyment, a need exists for alternative gaming systems in order to maintain or increase player enjoyment.

### SUMMARY OF THE INVENTION

In accordance with a first aspect of the present invention, there is provided a gaming system including:

a symbol selector arranged to select a plurality of symbols for display at a plurality of display positions;

a win criterion selector arranged to facilitate selection by a player of at least one win criterion from a plurality of win criteria;

an outcome evaluator arranged to determine whether the selected symbols correspond to a winning outcome; and

a prize allocator arranged to allocate a prize to a player when a winning outcome exists and to allocate a different prize to the player when the selected symbols satisfy the selected win criterion.

In one embodiment, the win criterion is a specific win line.

In one embodiment, the win criterion is a win combination selectable from a plurality of win combinations. The win combination may be a scatter combination or a defined symbol combination.

In one embodiment, the prize allocator is arranged to allocate an increased prize to the player when the selected symbol combination coincides with the selected win criterion.

In one embodiment, the prize is a monetary prize and the prize allocator is arranged to allocate an increased monetary value prize to the player when the selected symbols satisfy the selected win criterion.

In one embodiment, the prize is at least one free game and the prize allocator is arranged to allocate an increased number of free games to the player when the selected symbols satisfy the selected win criterion.

The increased prize may be double the prize awarded to a player when the selected symbols do not satisfy the selected win criterion.

The gaming system may be arranged to operate in normal game mode wherein at least one base game is implemented and special game mode wherein at least one feature game is implemented.

In one embodiment, the prize allocator is arranged to allocate an increased prize to the player in respect of a winning outcome occurring during normal game mode and/or special game mode.

The gaming system may be arranged to commence special game mode when a specific game outcome occurs. With this embodiment, the prize allocator may be arranged to modify a condition associated with special game mode, such as the number of free games implemented during special game mode, when the specific game outcome satisfies the selected win criterion.

In addition or alternatively, the gaming system may be arranged to commence special game mode on the basis of a game event occurring during a game such as display of a particular symbol, in response to player input, based on the amount or type of bet placed, or when a special game is purchased by a player.

In an embodiment wherein the win criterion is a selected win line or a scatter combination, display positions corresponding to the specific win line may be highlighted relative to display positions which do not correspond to the specific win line. The display positions may be highlighted by increasing the intensity of display positions associated with the win line relative to display positions not associated with the specific win line, by displaying display positions associated with the specific win line in a different colour relative to display positions not associated with the specific win line, or by causing the displaying display positions associated with the specific win line to flash.

The gaming system may be implemented as a stand alone gaming machine or across a network.

In one embodiment, one or more of the symbol selector, win criterion selector, prize allocator and the outcome evaluator is constituted, at least in part, by a processor executing program code stored in a memory.

In one embodiment, the gaming system includes a game play mechanism operable to place a wager and the outcome evaluator evaluates the outcome based on the wager.

In accordance with a second aspect of the present invention, there is provided a method of gaming including:

selecting a plurality of symbols for display at a plurality of display positions;

facilitating selection by a player of a win criterion from a plurality of win criteria;

determining whether the selected symbols correspond to a winning outcome; and

allocating a prize to a player when a winning outcome exists and allocating a different prize to the player when the selected symbols satisfy the selected win criterion.

In accordance with a third aspect of the present invention, there is provided a computer program arranged when loaded into a computer to instruct the computer to operate in accordance with a gaming system including:

a symbol selector arranged to select a plurality of symbols for display at a plurality of display positions;

a win criterion selector arranged to facilitate selection by a player of at least one win criterion from a plurality of win criteria;

an outcome evaluator arranged to determine whether the selected symbols correspond to a winning outcome; and

a prize allocator arranged to allocate a prize to a player when a winning outcome exists and to allocate a different prize to the player when the selected symbols satisfy the selected win criterion.

In accordance with a fourth aspect of the present invention, there is provided a computer readable medium having computer readable program code embodied therein for causing a computer to operate in accordance with a gaming system including:

a symbol selector arranged to select a plurality of symbols for display at a plurality of display positions;

a win criterion selector arranged to facilitate selection by a player of at least one win criterion from a plurality of win criteria;

an outcome evaluator arranged to determine whether the selected symbols correspond to a winning outcome; and

a prize allocator arranged to allocate a prize to a player when a winning outcome exists and to allocate a different prize to the player when the selected symbols satisfy the selected win criterion.

In accordance with a fifth aspect of the present invention, there is provided a data signal having computer readable program code embodied therein for causing a computer to operate in accordance with a gaming system including:

a symbol selector arranged to select a plurality of symbols for display at a plurality of display positions;

a win criterion selector arranged to facilitate selection by a player of at least one win criterion from a plurality of win criteria;

an outcome evaluator arranged to determine whether the selected symbols correspond to a winning outcome; and

a prize allocator arranged to allocate a prize to a player when a winning outcome exists and to allocate a different prize to the player when the selected symbols satisfy the selected win criterion.

### BRIEF DESCRIPTION OF THE DRAWINGS

Certain embodiments of the present invention will now be described, by way of example only, with reference to the accompanying drawings, in which:

FIG. 1 is a schematic block diagram of core components of a gaming system in accordance with an embodiment of the present invention;

FIG. 2 is a schematic block diagram of functional components of a gaming system in accordance with an embodiment of the present invention;

FIG. 3 is a diagrammatic representation of a gaming system in accordance with an embodiment of the present invention with the gaming system implemented in the form of a stand alone gaming machine;

FIG. 4 is a schematic block diagram of operative components of the gaming machine shown in FIG. 3;

FIG. 5 is a schematic block diagram of components of a memory of the gaming machine shown in FIG. 3;

FIG. 6 is a schematic diagram of a gaming system in accordance with an alternative embodiment of the present invention with the gaming system implemented over a network;

FIG. 7 is a flow diagram illustrating game play of a gaming system in accordance with an embodiment of the present invention; and

FIG. 8 is a diagrammatic representation of an example screen displayed by a gaming system in accordance with an embodiment of the present invention during implementation of a game.

Further aspects of the present invention will be apparent from the following description, given by way of example and with reference to the accompanying drawings. Also, various embodiments of the aspects described in the preceding paragraphs will be apparent from the appended claims, the following description and/or the accompanying drawings. It should be understood, however, that the present invention is not limited to the arrangements and instrumentality shown in the attached drawings.

### DESCRIPTION OF AN EMBODIMENT OF THE INVENTION

The present gaming system operates such that at least during a portion of a game implemented by the gaming system, a player is provided with an option to select a win criterion from a plurality of available win criteria. If the displayed symbol combination coincides with the selected special win criterion, a different prize is allocated to a player. The criterion may be a win line, a win combination such as a defined symbol combination or a defined symbol pattern, or any other suitable win criterion.

Referring to the drawings, there is shown a schematic block diagram of a gaming system 10 arranged to implement a probabilistic game of the type wherein several symbols from a set of symbols are randomly displayed, and a game outcome is determined on the basis of the displayed symbols. The system may have a single mode of operation or may be of the type including multiple game modes such as operable in normal game mode wherein a base game is implemented and special game mode wherein a feature game is implemented.

With some such probabilistic games, the set of symbols used during normal game mode include standard symbols and function symbols, and the game outcome is determined on the basis of the displayed standard symbols and the function associated with any displayed function symbol. For example, standard symbols may resemble fruit such as apples, pears and bananas with a win outcome being determined when a predetermined number of the same fruit appear on a display along a win line, or are displayed according to defined outcome patterns such as scattered, and so on. The function associated with a function symbol may be for example a wild function wherein display of the function symbol is treated during consideration of the game outcome as any of the standard symbols. A function symbol may be represented as the word “WILD”, a star, or by any other suitable word or symbol. Other functions are also envisaged such as scatter functions, multiplier functions, repeat win functions, jackpot functions and feature commencement functions.

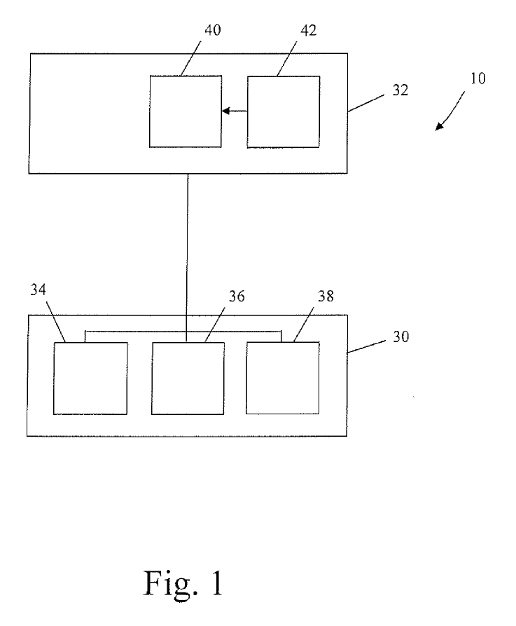

Referring to FIG. 1, a schematic diagram of core components of a gaming system 10 in accordance with the present embodiment is shown. The core components include a player interface 30 and a game controller 32. The player interface 30 is arranged to enable interaction between a player and the gaming system and for this purpose includes input/output components for the player to enter instructions and play the game.

Components of the player interface 30 may vary but will typically include a credit mechanism 34 to enable a player to input credits and receive payouts, one or more displays 36 which may include a touch screen, and a game play mechanism 38 arranged to enable a player to input game play instructions.

The game controller 32 is in data communication with the player interface 30 and typically includes a processor 40 arranged to process game play instructions and output game player outcomes to the display 36. Typically, the game play instructions are stored as program code in a memory 42 that can also be hardwired. It will be understood that in this specification the term “processor” is used to refer generically to any device that can process game play instructions and may include a microprocessor, microcontroller, programmable logic device or other computational device such as a personal computer or a server.

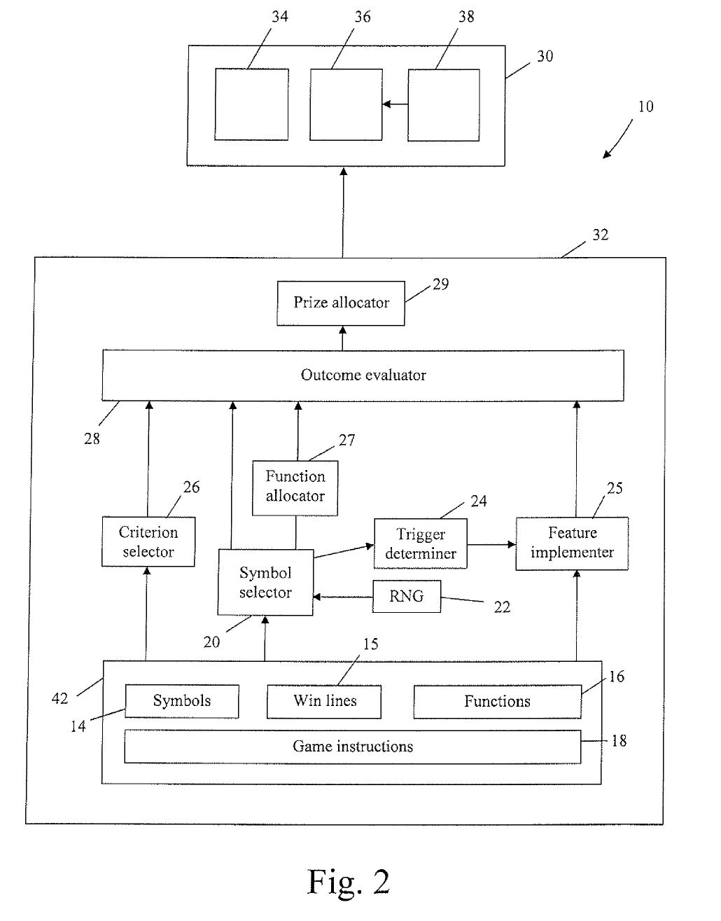

A functional diagram illustrating operative components of the game controller 32 is shown in FIG. 2.

The memory 42 is arranged to store symbols data 14 indicative of a plurality of symbols, in the present example associated with a plurality of reels, win lines data 15 indicative of available win lines, function data 16 indicative of one or more functions allocatable to the symbols, and game instruction data 18 indicative of game instructions usable by the gaming machine 10 to control operation of the game.

The game controller 32 includes a symbol selector 20 which is arranged to select several symbols from the available symbols 15 for display to a player in a plurality of display positions, in this example by spinning reels containing the symbols and stopping the reels so as to display at least one symbol on each reel. In this example, the selection carried out by the symbol selector 20 is made using a random number generator 22.

During special game mode, a feature game is implemented which for example may be of a type wherein a player is provided with several free games.

It will be appreciated that the random number generator 22 may be of a type which is arranged to generate pseudo random numbers based on a seed number, and that in this specification the term “random” will be understood accordingly to mean truly random or pseudo random.

With this embodiment, the game controller 32 also includes a trigger determiner 24 arranged to determine whether a trigger condition exists and to instruct a feature implementer 25 to implement special game mode when a trigger condition has been detected. Such a trigger condition may be display of a particular symbol or combination of symbols.

The game controller 32 also includes a criterion selector 26 which facilitates selection by a player of a special win criterion from the available win criteria stored in the memory 42. For example, the criterion selector 26 may facilitate selection of a special win wine from a plurality of win lines.

In this example, the game controller 32 also includes a function allocator 27 arranged to select and allocate one or more functions to one or more symbols. Such functions include a wild function, a scatter function, or any other function which may be applied to a symbol or to the game.

The game controller 32 also includes an outcome evaluator 28 which in accordance with the game instructions 18 determines game outcomes based on the symbols selected for display to the player by the symbol selector 20 and on the special win criterion selected by a player.

The game controller 32 also includes a prize allocator 29 arranged to allocate a prize to a player when a winning outcome exists, the type of prize being dependent on the winning outcome and whether the winning outcome coincides with a selected win criterion.

In the embodiments described below, the symbol selector 20, the trigger determiner 24, feature implementer 25, the criterion selector 26, the function allocator 27, and the outcome evaluator 28, and the prize allocator 29 are at least partly implemented using the processor 40 and associated software, although it will be understood that other implementations are envisaged.

The gaming system 10 can take a number of different forms.

In a first form, a stand alone gaming machine is provided wherein all or most components implementing the game are present in a player operable gaming machine.

In a second form, a distributed architecture is provided wherein some of the components implementing the game are present in a player operable gaming device and some of the components implementing the game are located remotely relative to the gaming device. For example, a “thick client” architecture may be used wherein part of the game is executed on a player operable gaming terminal and part of the game is executed remotely, such as by a gaming server; or a “thin client” architecture may be used wherein most of the game is executed remotely such as by a gaming server and a player operable gaming terminal is used only to display audible and/or visible gaming information to the player and receive gaming inputs from the player.

However, it will be understood that other arrangements are envisaged. For example, an architecture may be provided wherein a gaming device is networked to a gaming server and the respective functions of the gaming device and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

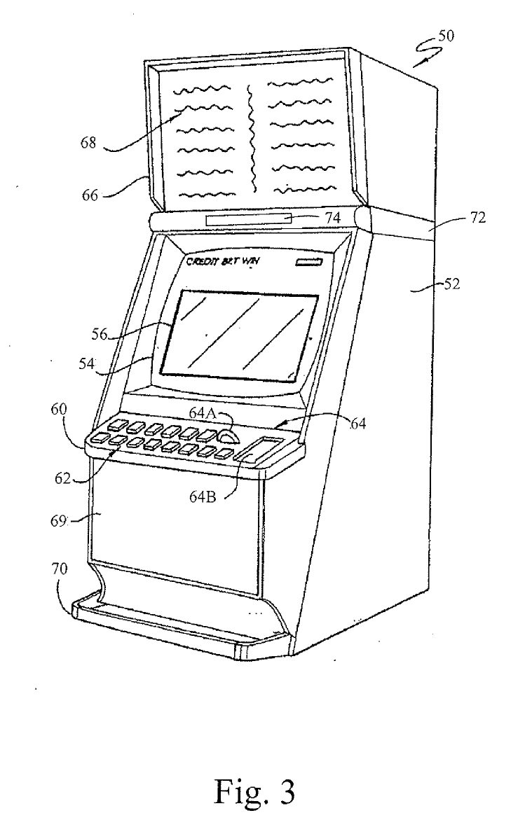

A gaming system in the form of a stand alone gaming machine 50 is illustrated in FIG. 3. The gaming machine 50 includes a console 52 having a display 54 on which is displayed representations of a game 56 that can be played by a player. A mid-trim 60 of the gaming machine 50 houses a bank of buttons 62 for enabling a player to interact with the gaming machine, in particular during gameplay. The mid-trim 60 also houses a credit input mechanism 64 which in this example includes a coin input chute 64A and a bill collector 64B. Other credit input mechanisms may also be employed, for example, a card reader for reading a smart card, debit card or credit card.

A top box 66 may carry artwork 68, including for example pay tables and details of bonus awards and other information or images relating to the game. Further artwork and/or information may be provided on a front panel 69 of the console 52. A coin tray 70 is mounted beneath the front panel 69 for dispensing cash payouts from the gaming machine 50.

The display 54 is in the form of a video display unit, particularly a cathode ray tube screen device. Alternatively, the display 54 may be a liquid crystal display, plasma screen, or any other suitable video display unit. The top box 66 may also include a display, for example a video display unit, which may be of the same type as the display 54, or of a different type. The display 54 may include a touch screen usable by a player to interact with the gaming machine, in particular during game play.

The display 54 in this example is arranged to display representations of several reels, each reel of which has several associated symbols. Typically 3, 4 or 5 reels are provided. During operation of the game, the reels first appear to rotate then stop with typically three symbols visible on each reel. Game outcomes are determined on the basis of the visible symbols together with any special functions associated with the symbols.

A player marketing module (PMM) 72 having a display 74 is connected to the gaming machine 50. The main purpose of the PMM 72 is to allow the player to interact with a player loyalty system. The PMM has a magnetic card reader for the purpose of reading a player tracking device, for example as part of a loyalty program. However other reading devices may be employed and the player tracking device may be in the form of a card, flash drive or any other portable storage medium capable of being read by the reading device. In this example, the PMM 62 is a Sentinel III device produced by Aristocrat Technologies Pty Ltd.

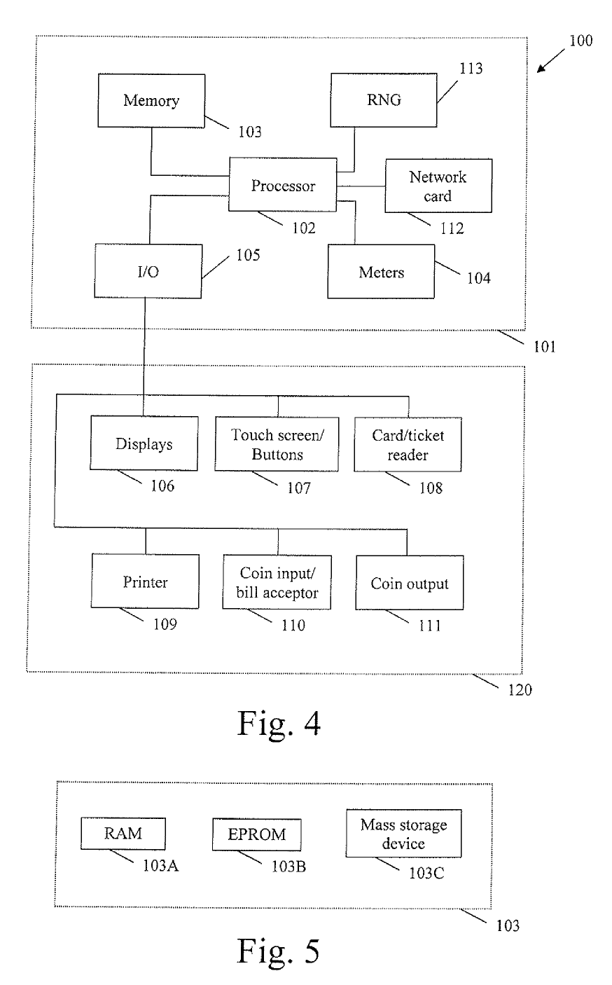

FIG. 4 shows a block diagram of operative components of a gaming device 100 which may be the same as or different to the gaming machine shown in FIG. 3.

The gaming device 100 includes a game controller 101 having a processor 102. Instructions and data to control operation of the processor 102 in accordance with certain embodiments of the present invention are stored in a memory 103 which is in data communication with the processor 102.

Typically, the gaming device 100 will include both volatile and non-volatile memory and more than one of each type of memory, with such memories being collectively represented by the memory 103.

FIG. 5 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

The gaming device has hardware meters 104 for purposes including ensuring regulatory compliance and monitoring player credit, an input/output (I/O) interface 105 for communicating with a player interface 120 of the gaming device 100, the player interface 120 having several peripheral devices. The input/output interface 105 and/or the peripheral devices may be intelligent devices with their own memory for storing associated instructions and data for use with the input/output interface or the peripheral devices. A random number generator module 113 generates random numbers for use by the processor 102.

In the example shown in FIG. 4, the peripheral devices that communicate with the game controller 101 include one or more displays 106, a touch screen and/or bank of buttons 107, a card and/or ticket reader 108, a printer 109, a bill acceptor and/or coin input mechanism 110 and a coin output mechanism 111. Additional hardware may be included as part of the gaming machine 100, or hardware may be omitted based on the specific implementation.

In addition, the gaming device 100 may include a communications interface, for example a network card 112. The network card may, for example, send status information, accounting information or other information to a central controller, server or database and receive data or commands from the central controller, server or database.

It is also possible for the operative components of the gaming device 100 to be distributed, for example input/output devices 106,107,108,109,110,111 may be provided remotely from the game controller 101.

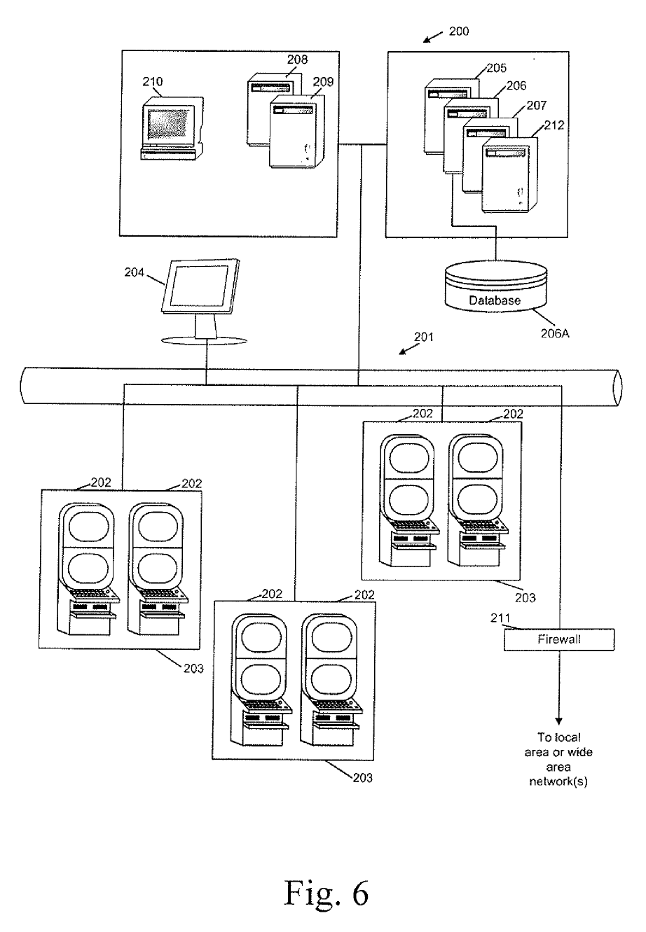

FIG. 6 shows a gaming system 200 in accordance with an alternative embodiment. The gaming system 200 includes a network 201, which for example may be an Ethernet network, a LAN or a WAN. In this example, three banks 203 of two gaming devices 202 are connected to the network 201. The gaming devices 202 provide a player operable interface and may be the same as the gaming machines 40,100 shown in FIGS. 3 and 4, or may have simplified functionality depending on the rules and/or guidelines for implementing game play. While banks 203 of two gaming devices are illustrated in FIG. 6, banks of one, three or more gaming devices are also envisaged.

One or more displays 204 may also be connected to the network 201. The displays 204 may, for example, be associated with one or more banks 203 of gaming devices. The displays 204 may be used to display representations associated with game play on the gaming devices 202, and/or used to display other representations, for example promotional or informational material.

In a thick client embodiment, a game server 205 implements part of the game played by a player using a gaming device 202 and the gaming device 202 implements part of the game. With this embodiment, as both the game server 205 and the gaming device 202 implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game.

In a variation of the above thick client embodiment, the gaming device 202 is a gaming machine arranged to implement the game, with the game server 205 functioning merely to serve data indicative of a game to the gaming machine 202 for implementation.

With this implementation, a data signal containing a computer program usable by the gaming machine to implement the gaming system may be transferred from the game server to the client terminal, for example in response to a request by the gaming machine.

In a thin client embodiment, the game server 205 implements most or all of the game played by a player using a gaming terminal 202 and the gaming terminal 202 essentially provides only the player interface. With this embodiment, the game server 205 provides the game controller. The gaming terminal will receive player instructions, and pass the instructions to the game server which will process them and return game play outcomes to the gaming terminal for display. In a thin client embodiment, the gaming terminal could be computer terminals, e.g. PCs running software that provides a player interface operable using standard computer input and output components.

Servers are also typically provided to assist in the administration of the gaming system 200, including for example a gaming floor management server 208 and a licensing server 209 to monitor the use of licenses relating to particular games. An administrator terminal 210 is provided to allow an administrator to monitor the network 201 and the devices connected to the network.

The gaming system 200 may communicate with other gaming systems, other local networks such as a corporate network, and/or a wide area network such as the Internet, for example through a firewall 211.

A loyalty program server 212 may also be provided.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random number generator engine. Alternatively, a separate random number generator server could be provided.

Examples of specific implementations of the gaming system will now be described.

In this example, the gaming system is operable in normal game mode and special game mode and the gaming system includes five reels, each of which has an associated set of symbols.

The reels include standard symbols and optionally one or more function symbols and win outcomes are determined on the basis of the symbols visible at the display positions when the reels stop rotating.

Typically, a player will purchase or otherwise obtain win entitlements such as several win lines which are used in the game to determine win outcomes. If the displayed symbols on the reels have symbols associated with a winning combination such as disposed on a win line, the player wins a prize.

The gaming system may be arranged to commence special game mode when a predetermined game outcome occurs, and special game mode may include one or more free games. Special game mode may commence automatically on the basis of a game event occurring during a game such as display of a particular symbol, based on game outcomes determined by the gaming system, or may be prompted by a player pressing a button on the gaming system 10, 40, 100 after the player has identified that a game outcome corresponding to special game mode requirements has occurred.

The gaming system 10, 40, 100 may also be arranged so as to determine eligibility for special game mode, for example based on the amount or type of bet placed, based on certain time periods and so on.

Special game mode may also be arranged to commence when a special game is purchased by a player.

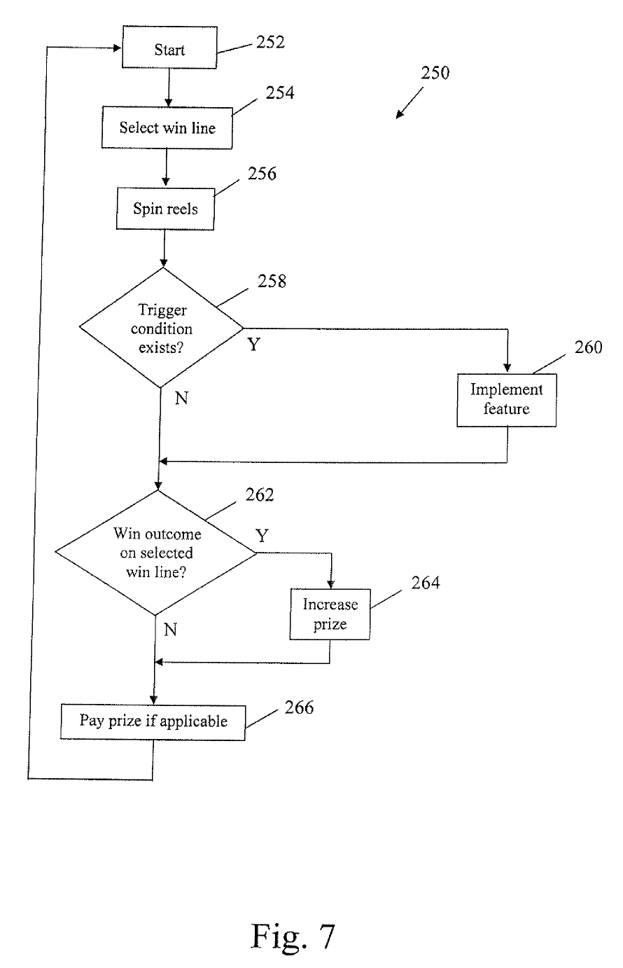

A specific example will now be described in relation to flow diagram 250 shown in FIG. 7 which illustrates steps 252 to 266 of a method of gaming implemented by the gaming system according to the present embodiment.

In this example, five virtual reels are provided and, as such, representations of the reels are displayed on a graphical display device 44.

During implementation of a game, a player is provided with an opportunity to select a win criterion, in this example a win line 254 from a plurality of available win lines. The reels are spun 254 and subsequently stopped to display a symbol at each display position. If a trigger condition does not exist 258 to cause commencement of special game mode, the outcome generator 28 determines 262 whether the symbols displayed at the display positions correspond to a winning outcome and whether the winning outcome coincides with the selected win line. If a winning outcome exists and the winning outcome coincides with the selected win line, the prize associated with the winning outcome is changed, for example, the prize associated with the winning outcome is increased, such as doubled.

If a trigger condition exists 258, special game mode commences which causes implementation of a special feature.

In one embodiment, the system may be arranged such that if the trigger condition is a combination of symbols which coincide with a selected special win line, the prize associated with a winning outcome achieved during the feature game is changed, such as doubled.

It will be understood that the prize awarded to a player may be a monetary prize, may be in the form of a number of free games which may be feature games, or may be in any other suitable form. For example, in the above example wherein a combination of symbols triggers special game mode and the combination of displayed symbols coincides with the special win line, the number of free games awarded to a player may be increased, such as doubled.

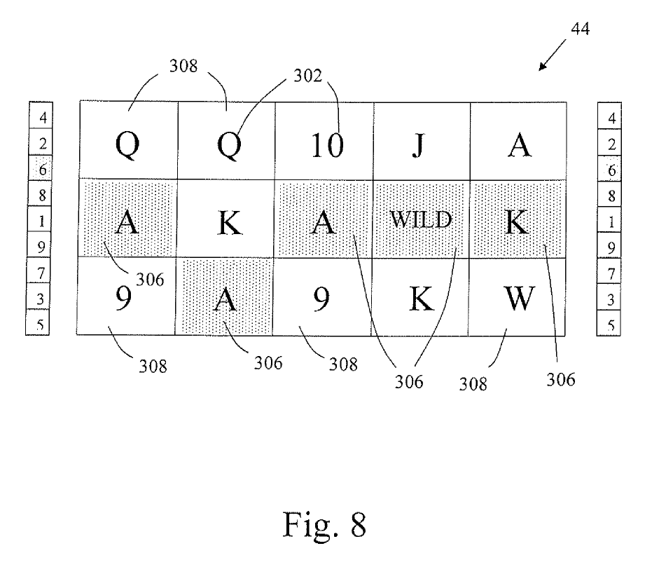

In FIG. 8, an example display 54 including a plurality of selected symbols 302 is shown diagrammatically. The display 54 includes a win line indicator 304 for each available win line. By highlighting a win line indicator 304, an indication can be provided to a player as to the win line which has been selected. In the example shown in FIG. 8, win line 6 has been selected by a player as a special win line and the display positions 306 corresponding to the special win line are highlighted relative to display positions 308 which do not correspond to the special win line.

In the present example, after selection of symbols has occurred a win outcome including 4 ACE symbols (3×ACE symbols plus a WILD symbol) exists. This outcome also coincides with the selected special win line, and as a consequence the prize associated with 4×ACE symbols is doubled and awarded to the player.

In addition or alternatively, the gaming system may be arranged such that if the selected symbols trigger special game mode, occurrence of the triggering combination on the special win line has the effect of modifying one or more prizes awarded to a player during special game mode. For example, if the combination 3×ACE symbols plus WILD symbol shown in FIG. 8 causes special game mode to commence, and the combination coincides with a special win line, the number of free games during special mode may be increased, such as doubled, or a prize associated with any win during special game mode may be increased, such as doubled.

As an alternative to the present example wherein a player selects a win criterion in the form of a special win line, it will be understood that other variations are possible. For example, the win criterion may be a defined symbol combination such as 4 ACE symbols, and a prize allocated to the player increased when a win combination including 4 ACES is achieved.

In the claims of this application and in the description of the invention, except where the context indicates otherwise due to express language or necessary implication, the words “comprise” or variations such as “comprises” or “comprising” are used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

Modifications and variations as would be apparent to a skilled addressee are deemed to be within the scope of the present invention.

It will be appreciated by persons skilled in the art that numerous variations and/or modifications may be made to the invention as shown in the specific embodiments and/or aspects without departing from the spirit or scope of the invention as broadly described. The present embodiments and aspects are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. It will be understood that the invention disclosed and defined in this specification extends to all alternative combinations of two or more of the individual features mentioned or evident from the text or drawings. All of these different combinations constitute various alternative aspects of the invention.

The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

1. A gaming system comprising:
a symbol selector arranged to select a plurality of symbols for display at a plurality of display positions;
a win criterion selector arranged to facilitate selection by a player of at least one win criterion from a plurality of win criteria;
an outcome evaluator arranged to determine whether the selected symbols correspond to a winning outcome; and
a prize allocator arranged to allocate a prize to a player when a winning outcome exists and to allocate a different prize to the player when the selected symbols satisfy the selected win criterion.

2. A gaming system as claimed in claim 1, wherein the win criterion is a specific win line.

3. A gaming system as claimed in claim 2, wherein the specific win line is selectable from a plurality of win lines.

4. A gaming system as claimed in claim 2, wherein display positions corresponding to the specific win line are highlighted relative to display positions which do not correspond to the specific win line.

5. A gaming system as claimed in claim 4, wherein the display positions are highlighted by increasing the intensity of display positions associated with the specific win line relative to display positions not associated with the specific win line, by displaying display positions associated with the specific win line in a different colour relative to display positions not associated with the specific win line, or by causing the displaying display positions associated with the specific win line to flash.

6. A gaming system as claimed in claim 1, wherein the win criterion is a win combination.

7. A gaming system as claimed in claim 6, wherein the win combination is a scatter combination or a defined symbol combination.

8. A gaming system as claimed in claim 1, wherein the prize allocator is arranged to allocate an increased prize to the player when the selected symbols satisfy the selected win criterion.

9. A gaming system as claimed in claim 8, wherein the prize is a monetary prize and the prize allocator is arranged to allocate an increased monetary value prize to the player when the selected symbols satisfy the selected win criterion.

10. A gaming system as claimed in claim 8, wherein the prize is at least one free game and the prize allocator is arranged to allocate an increased number of free games to the player when the selected symbols satisfy the selected win criterion.

11. A gaming system as claimed in claim 8, wherein the increased prize is double the prize awarded to a player when the selected symbols do not satisfy the selected win criterion.

12. A gaming system as claimed in claim 1, wherein the gaming system is arranged to operate in normal game mode wherein at least one base game is implemented and special game mode wherein at least one feature game is implemented.

13. A gaming system as claimed in claim 12, wherein the prize allocator is arranged to allocate an increased prize to the player when a selected win criterion is satisfied during normal game mode and/or special game mode.

14. A gaming system as claimed in claim 12, wherein the gaming system is arranged to commence special game mode when a specific game outcome occurs.

15. A gaming system as claimed in claim 14, wherein the prize allocator is arranged to modify a condition associated with special game mode when the specific game outcome satisfies the selected win criterion.

16. A gaming system as claimed in claim 15, wherein the prize allocator is arranged to modify the number of free games implemented during special game mode when the specific game outcome satisfies the selected win criterion.

17. A gaming system as claimed in claim 12, wherein the gaming system is arranged to commence special game mode on the basis of a game event occurring during a game.

18. A gaming system as claimed in claim 17, wherein the gaming system is arranged to commence special game mode in response to display of a particular symbol, in response to player input, based on the amount or type of bet placed, or when a special game is purchased by a player.

19. A gaming system as claimed in claim 1, wherein one or more of the symbol selector, win criterion selector, prize allocator and the outcome evaluator is constituted, at least in part, by a processor executing program code stored in a memory.

20. A gaming system as claimed in claim 1, wherein the gaming system comprises a game play mechanism operable to place a wager and the outcome evaluator evaluates the outcome based on the wager.

21. A gaming system as claimed in claim 1, wherein the gaming system comprises a gaming machine.

22. A gaming system as claimed in claim 1, comprising a gaming terminal and a gaming server in networked communication with the gaming terminal.

23. A method of gaming comprising:
selecting a plurality of symbols for display at a plurality of display positions;
facilitating selection by a player of a win criterion from a plurality of win criteria;
determining whether the selected symbols correspond to a winning outcome; and
allocating a prize to a player when a winning outcome exists and allocating a different prize to the player when the selected symbols satisfy the selected win criterion.

24. A method as claimed in claim 23, wherein the win criterion is a specific win line.

25. A method as claimed in claim 24, wherein the specific win line is selectable from a plurality of win lines.

26. A method as claimed in claim 23, comprising highlighting display positions corresponding to the specific win line relative to display positions which do not correspond to the specific win line.

27. A method as claimed in claim 26, comprising highlighting display positions by increasing the intensity of display positions associated with the specific win line relative to display positions not associated with the specific win line, by displaying display positions associated with the specific win line in a different colour relative to display positions not associated with the specific win line, or by causing the displaying display positions associated with the specific win line to flash.

28. A method as claimed in claim 23, wherein the win criterion is a win combination.

29. A method as claimed in claim 28, wherein the win combination is a scatter combination or a defined symbol combination.

30. A method as claimed in claim 23, comprising allocating an increased prize to the player when the selected symbol combination coincides with the selected win criterion.

31. A method as claimed in claim 30, wherein the prize is a monetary prize and the method comprises allocating an increased monetary value prize to the player when the selected symbol combination coincides with the selected win criterion.

32. A method as claimed in claim 30, wherein the prize is at least one free game and the method comprises allocating an increased number of free games to the player when the selected symbol combination coincides with the selected win criterion.

33. A method as claimed in claim 30, comprising doubling the prize awarded to a player when the selected symbol combination coincides with the selected win criterion.

34. A method as claimed in claim 23, comprising enabling operation in normal game mode wherein at least one base game is implemented and special game mode wherein at least one feature game is implemented.

35. A method as claimed in claim 34, comprising allocating an increased prize to the player in respect of a winning outcome occurring during normal game mode and/or special game mode.

36. A method as claimed in claim 34, comprising commencing special game mode when a specific game outcome occurs.

37. A method as claimed in claim 36, comprising modifying a condition associated with special game mode when the specific game outcome coincides with the selected win criteria.

38. A method as claimed in claim 37, comprising modifying the number of free games implemented during special game mode when the specific game outcome coincides with the selected win criteria.

39. A method as claimed in claim 34, comprising commencing special game mode on the basis of a game event occurring during a game such as display of a particular symbol, in response to player input, based on the amount or type of bet placed, or when a special game is purchased by a player.

40. A method as claimed in claim 23, comprising providing a processor and a memory, and executing code stored in the memory so as to implement one or more of the symbol selector, win criterion selector, prize allocator and the outcome evaluator.

41. A method as claimed in claim 23, comprising providing a game play mechanism operable to place a wager and the outcome evaluator evaluates the outcome based on the wager.

42. A computer readable medium having computer readable program code embodied therein for causing a computer to operate in accordance with a gaming system comprising
a symbol selector arranged to select a plurality of symbols for display at a plurality of display positions;
a win criterion selector arranged to facilitate selection by a player of at least one win criterion from a plurality of win criteria;
an outcome evaluator arranged to determine whether the selected symbols correspond to a winning outcome; and
a prize allocator arranged to allocate a prize to a player when a winning outcome exists and to allocate a different prize to the player when the selected symbols satisfy the selected win criterion.
